(19) United States
(12) Patent Application Publication
(10) Pub. No.: US 2010/0244748 A1
(43) Pub. Date: Sep. 30, 2010

(54) ROTATING BEACON

(75) Inventors: Daniel B. Haab, Springville, UT (US); Vaughn R. Staheli, Payson, UT (US); Jim Grady, Elko, NV (US)

Correspondence Address: HUSCH BLACKWELL SANDERS LLP, 190 Carondelet Plaza, Suite 600, ST. LOUIS, MO, 63105, US

(73) Assignee: HELLA, INC., Peachtree City, GA (US)

(21) Appl. No.: 12/716,371

(22) Filed: Mar. 3, 2010

Related U.S. Application Data
(60) Provisional application No. 61/157,041, filed on Mar. 3, 2009.

(51) Int. Cl. H05B 39/04

(52) U.S. Cl. 315/313

(57) ABSTRACT

A light beacon includes a base, a plurality of towers supported on the base, a first set of LEDs having a first color mounted on each of said towers and a second set of LEDs having a second color also mounted on each of said towers. A microprocessor in operative communication with each of the first and second LEDs is configured to illuminate the first set of LEDs through a defined channel either simultaneously or sequentially, at a user's option through a user interface. The processor is further configured to illuminate the second set of LEDs through a defined channel either simultaneously or sequentially at a user's option. A lens mounted on the housing directs light from the LEDs in a preconfigured distribution.

### CROSS-REFERENCE TO RELATED APPLICATION

This application claims the benefit of and priority to U.S. Provisional Patent Applications Ser. No. 61/157,041, filed Mar. 3, 2009, entitled ROTATING BEACON, which application is hereby incorporated by reference to the extent permitted by law.

### BACKGROUND OF THE INVENTION

1. Field of the Invention

The present invention is in the field of light beacons, particularly for construction and emergency vehicles.

2. Related Art

Emergency vehicles and construction vehicles traditionally used warning beacons that flash and/or rotate as a warning. Multiple colors are often preferred. In order to achieve rotation of the light, prior art devices have typically rotated the light itself, or, more recently, rotated a reflector to redirect the beam of a stationary light source. Such products had a finite life span and proved to be of limited durability and resistance to harsh conditions, including temperature extremes, impacts and vibrations.

Moreover, prior art devices achieved multiple color projection by including separate beacons or separate tinted lenses to achieve the desired multiplicity of colors. Similarly, where multiple patterns of flashing or rotation were required, a typical corresponding duplication of equipment and parts was required.

### SUMMARY OF THE INVENTION

The present invention is a multi-color, multi-pattern single beacon without moving mechanical parts. A light beacon includes a base, a plurality of towers supported on the base, a first set of LEDs having a first color mounted on each of said towers and a second set of LEDs having a second color also mounted on each of said towers. A microprocessor in operative communication with each of the first and second LEDs is configured to illuminate the first set of LEDs through a defined channel either simultaneously or sequentially, at a user's option through a user interface. The processor is further configured to illuminate the second set of LEDs through a defined channel either simultaneously or sequentially at a user's option. A lens mounted on the housing directs light from the LEDs in a preconfigured distribution.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded view of a beacon compatible with the invention.

FIG. 2 is a perspective view of the interior of the beacon incorporating the present invention.

FIG. 3 is a circuit diagram of a microprocessor of the present invention.

FIG. 4 is a circuit diagram of a driver switch LED channel.

FIG. 5 is a circuit diagram of a stabilization circuit interposed between the microprocessor and power source and the driver 62.

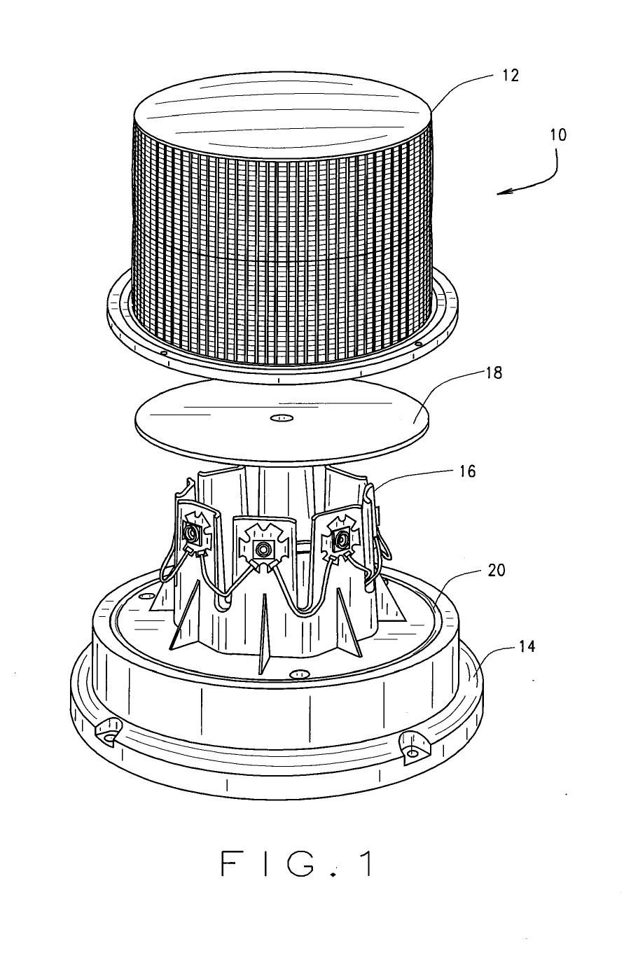

### DETAILED DESCRIPTION OF THE PREFERRED EMBODIMENTS

The following description of the preferred embodiment(s) is merely exemplary in nature and is in no way intended to limit the invention, its application, or uses.

The beacon of the invention 10 is comprised of a lens 12, a base 14, a plurality of LED mounting towers 16 and a shield 18. Shield 18 is an optional element that may be used to reduce the interference of sunlight during daylight use of the beacon. A grommet 20 is seated in an annular recess in base 14 in order to achieve a water tight seal of the lens 12 to the base 14 upon assembly.

Within the beacon, the plurality of LED mounting towers 16 are arranged around a central axis of the beacon. In the depicted embodiment, this arrangement of eight LED mounting surfaces is circular and equally spaced around said central axis. In the depicted embodiment, each of the LED mounts is substantially planar on an outward facing surface. In the depicted embodiment, base 14 and towers 16 are cast aluminum. As depicted, the towers and base are integrally formed, and have orthogonal support fins 42 to further supplement durability.

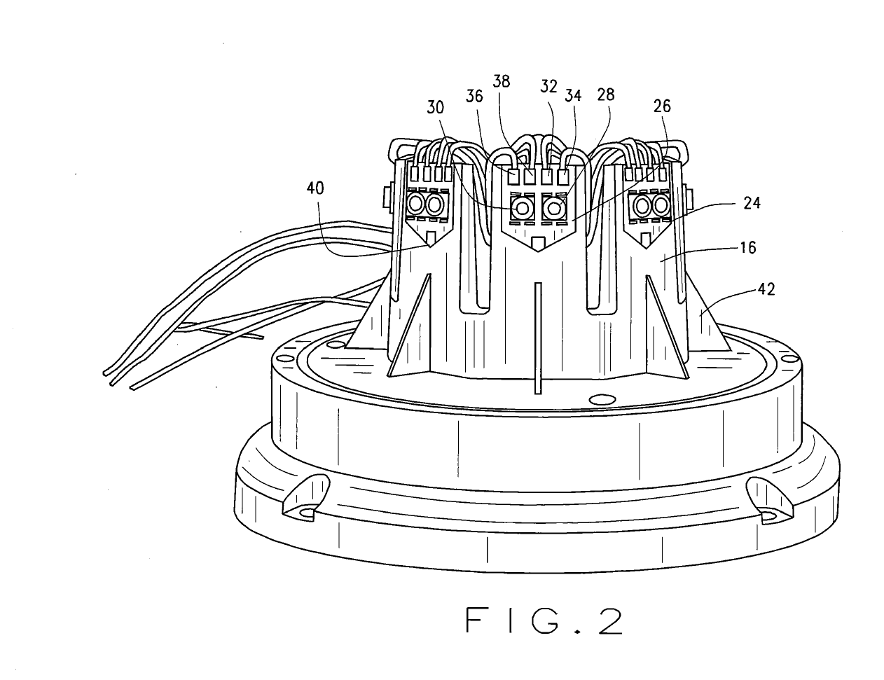

Each individual LED mounting tower 16 includes, in the embodiment depicted in FIG. 2, a recess 24. Whether with a recess 24 or otherwise, the LED mount 16 is configured to receive attachment thereto of an LED plate 26.

In the depicted embodiment, the LED plate 26 is a metal clad circuit board (MCCB). Both the MCCB 26 and recess 24 are dimensioned to include an alignment seat 40. In the depicted embodiment both the MCCB 26 and recess 24 are pentagonal in shape, with an alignment angle on the MCCB 26 corresponding to an alignment notch in the recess 24. In this manner, proper alignment during assembly is assured and maintenance of proper alignment during the useful life of the beacon is maintained through multiple cycles of vibration, possible impacts and temperature extremes. In this manner, the LEDs 28 and 30 on the MCCB 26 remain more securely positioned in their proper alignment with Fresnel and Scallop elements on the lens 12, thereby advantageously improving the durability of the beacon, as distinguished from prior art devices which, for example, would simply pin a printed circuit board vertically on a base, thereby creating a unit prone to misalignment of LEDs with properly corresponding lens features. Misalignment is problematic because it can take the beacon out of compliance with the strict Department of Transportation and Federal highway standards requiring minimum standards of illumination in strictly preconfigured beam distribution patterns. Continuing compliance requires continuing proper alignment of LEDs and lens elements.

Each LED MCCB plate 26 includes a first LED 28 and a second LED 30. In the depicted embodiment, the first LED 28 is a first color, for example blue, and the second LED 30 is a second color, for example amber. The LED plate 26 includes electrical connections 32 and 34 for conveying power and control signals to the first LED 28 and also electrical connections 36 and 38 for conveying power and control signals to the second LED 30. Each of the electrical connections 32, 34, 36 and 38 and similar connections for the plurality of LED plates 26 on the other towers are in operative communication with a central controller 50. The central controller 50 is configured to control the operation of first LED 28 and second LED 30, and their corresponding first and second LEDs on different LED plates 26 around the axis of the beacon in order that they may be activated in varying patterns. The central controller 50 is also configured to alternate or vary colors, according to the user selection. Selection may be between a plurality of different preconfigured combinations. For example, only the LEDs 28 of the first color may be used in a first operating mode in order to project a first color continuously. Similarly, only the second LEDs 30 with the second LED color may be used in order to project a different color continuously. The first LEDs may be activated in a second operating mode to flash in unison in all directions for 360 degrees, as may be the plurality of second LEDs 30. The first plurality of LEDs 28 may be activated sequentially in a third operating mode, with each first LED 28 being illuminated after an adjacent LED 28 has been turned off, in order to achieve a rotating effect of the first LED colors. Similarly, the second LEDs may also be activated in the third operating mode to achieve a rotating effect of the second color. Other operational modes may be configured to achieve other flashing, rotating, alternating or other lighting patterns. Thus, advantageously, continuous, rotating, flashing and alternative effects may be achieved without the necessity of moving parts within the beacon. Moreover, a single beacon can be used to project multiple colors, thereby obviating the need for multiple beacons.

The apparatus of the present invention advantageously manages fabrication and assembly costs in manufacturing and power usage during a useful lifetime while maintaining a required level of light output at a lower power demand through its advantageous configuration of components. The central processor 50 is configured to define channels 60, with each channel containing more than one individual LED. In the depicted embodiment, there being eight LED support towers, the circuit and processor define four channels. Other numbers of LEDs, towers and channels are within the scope of the present invention in varying combinations. Each channel 60 has a single driver 62. Each driver 62 regulates voltage and controls switching for multiple LEDs through switches 64. In the depicted embodiment, each channel 60 and driver 62 drives four LEDs on two towers. The configuration pairs two LEDs of a first color 28 on two adjacent towers 16 and selectively drives them to be illuminated upon a signal from microprocessor 50 through connections 52. In the depicted embodiment, channel 60 is configured such that if a first pair of LEDs of a first color 28 are illuminated, then the other corresponding pair of LEDs of a second color 30, also on the same two adjacent pillars 16, are not illuminated.

Federal, state and local regulations require certain minimums of lumens output in strictly defined beam distributions. The illumination of a pair of LEDs of a single color achieves a quantity of light output sufficient to maintain the required minimum lumens of illumination delivered through the lens to the preconfigured, regulated beam distribution with a minimum number of components while using a minimal degree of power.

The configuration of groups of LEDs which are pairs in the depicted embodiment, also allows the execution of sequential illumination of channels and their corresponding pairs in order to achieve a rotating effect in the beacon light distribution. That is, controller 50 through channel 60, driver 62 and switch 64 illuminates a first pair of LEDs, which are oriented through a first angular range of beam distribution, which may be substantially about 90 degrees in the depicted embodiment. After a preconfigured time, the first channel and first pair of LEDs are turned off, and a next adjacent channel and corresponding pair of LEDs is illuminated. This process repeats in order to generate a rotating beam from the beacon. Alternately, all channels and all LEDs having a first color may be illuminated at once for a 360 degree continuous beam distribution. A third alternative is that all channels and corresponding pairs of LEDs of a single color may flash. Other illumination patterns are configurable without departing from the scope of the invention.

By associating a pair of a first color of LEDs 28 and also a pair of a second color of LEDs 30 with the single channel 60, the same beacon can deliver multicolor functionality, which heretofore in the prior art could only be achieved through installing two different beacons. Each beam distribution pattern, 360 degree continuous illumination, flashing or rotating may be executed in either color.

The processor 50 may be in operative communication with a user interface 70. By way of illustration and not limitation, user interface 70 may include a three-way switch 72 for alternating between continuous illumination, rotating or flashing and include a second switch or mode 74 for designating a color. In a depicted embodiment, the processor 50 and the circuits are configured such that LEDs of a first color 28 cannot be illuminated simultaneously with LEDs of a second color 30, on the same channel.

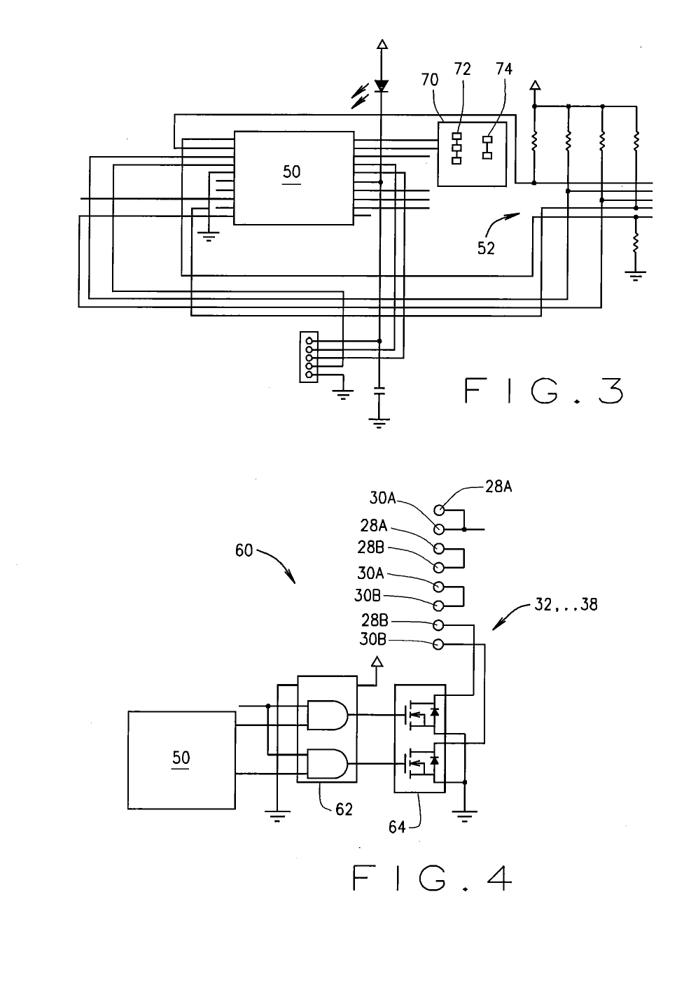

FIG. 3 is a circuit diagram of a microprocessor of the present invention. The processor 50 is configured as disclosed herein, and signals the channels 60 through lines 52.

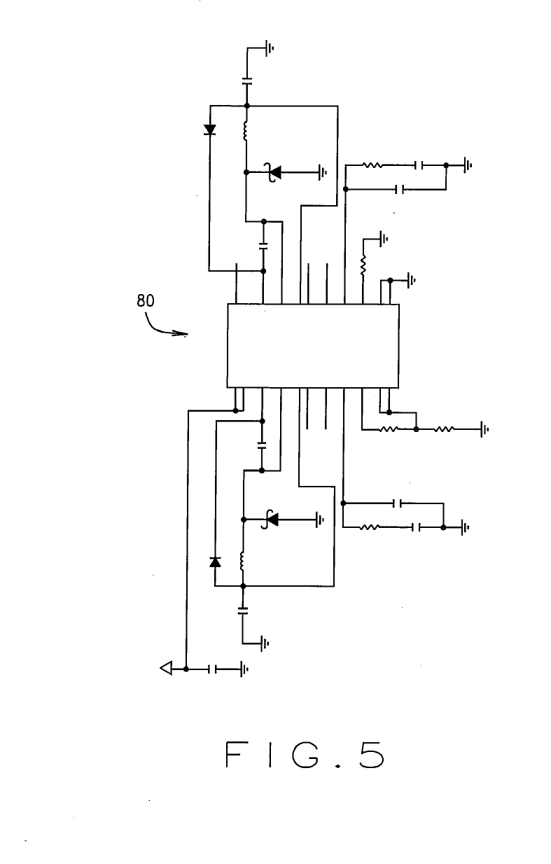

FIG. 4 is a circuit diagram of a channel 60, driver 62 and switch 64. LEDs 28 are two in number in the depicted embodiment, 28A and 28B. LEDs 30 are two in number in the depicted embodiment, 30A and 30B. Through lines 32, 34, 36 and 38, the LEDs are controlled as described above.

FIG. 5 is a circuit diagram of a stabilization circuit 80 interposed between the microprocessor 50 and power source and the driver 62.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A light beacon comprising:
a base;
a plurality of towers supported on said base;
a first LED having a first color mounted on each of said towers;
a second LED having a second color mounted on each of said towers;
a microprocessor in operative communication with each of said first LEDs and each of said second LEDs, said microprocessor being configured to illuminate a said first LED on said towers through a channel, said illumination of said first LED being either simultaneous or sequential, at a user's option through a user interface;
said processor being further configured to illuminate said second LEDs on said towers through a channel, said illumination of said second LEDs being either simultaneous or sequential at a user's option through a user interface; and
a lens mountable on said housing, said mounting encapsulating said towers and said LEDs, and said lens being configured to direct light from said LEDs in a preconfigured distribution.

2. A light beacon comprising a base;
a plurality of towers supported on said base;
a first LED having a first color mounted on each of said towers;
a second LED having a second color mounted on each of said towers:
a microprocessor in operative communication with each of said first LEDs and said second LEDs, said microprocessor being configured to illuminate any first group of said first LEDs, said first group being on two adjacent ones of said towers, and to illuminate a second group of said first LEDs, said second group being on a next two adjacent ones of said towers, said illumination being either simultaneous or sequential at a user's option through a user interface; and
said microprocessor being configured to illuminate any first group of said second LEDs, said first group being on two adjacent ones of said towers, and to illuminate a second group of said second LEDs, said second group being on a next two adjacent ones of said towers, said illumination being either simultaneous or sequential at a user's option through a user interface;
a lens, said lens being mounted on said base, said mounting encapsulating said towers and said LEDs and said lens being configured to direct light from said LEDs in a preconfigured distribution.

3. The light beacon of claim 2 wherein each of said first groups of LEDs and each of said second groups of LEDs are driven by a single driver.

4. The light beacon of claim 2 further comprising a single driver in operative communication to drive one of said first groups of said first LEDs and one of said second groups of said second LEDs.

5. The light beacon of claim 2 further comprising said groups being pairs.
